(19) United States
(12) Patent Application Publication
(10) Pub. No.: US 2005/0190488 A1
(43) Pub. Date: Sep. 1, 2005

(54) Data recording disk drive with nonplanar plate surfaces for damping out-of-plane disk vibration

(76) Inventors: Andre S. Chan, Milpitas, CA (US); Ferdinand Hendriks, Morgan Hill, CA (US); Toshiki Hirano, San Jose, CA (US); Manoj Keshavan, San Jose, CA (US)

Correspondence Address: THOMAS R. BERTHOLD, 18938 CONGRESS JUNCTION COURT, SARATOGA, CA, 95070, US

(21) Appl. No.: 10/788,953

(22) Filed: Feb. 26, 2004

(51) Int. Cl. G11B 33/14

(52) U.S. Cl. 360/97.02

(57) ABSTRACT

A data recording disk drive has damping plates with nonplanar surfaces for reducing flow-induced, out-of-plane vibration of the disks. The nonplanar damping plates reduce spindle motor torque, as compared with planar damping plates, while reducing the turbulent intensity. Each damping plate has a nonplanar surface that results in spacing between the plate surface and its associated disk surface that varies in the radial direction. The nonplanar surface may be a pattern of surface irregularities or features that may be arranged in concentric patterns, such as a pattern of concentric grooves, depressions or protuberances. The nonplanar surface may be shaped as a section of a conic surface so that in the radial direction the spacing between the damping plate surface and its associated disk surface varies linearly. For the disk surfaces facing the top and bottom of the disk housing, the nonplanar surfaces are applied to the top and bottom of the disk housing. Thus, in the single disk case, no separate damping plate is needed.

### TECHNICAL FIELD

This invention relates generally to data recording disk drives, such as magnetic recording hard disk drives, and more specifically to such disk drives with damping plates for reducing flow-induced out-of-plane disk vibration as well as flow-induced arm and suspension vibration.

### BACKGROUND OF THE INVENTION

Data recording disk drives have a stack of recording disks rotated by a spindle motor, and an actuator that moves the read/write heads across the surfaces of the rotating disks. Each read/write head is formed on an air-bearing slider attached to one end of a suspension. The suspension is attached at its other end to a rigid arm of the actuator and allows the slider to pitch and roll on a bearing of air generated by the rotating disk. The trend in future disk drives is a continual decrease in the spacing of the data tracks to increase the data storage density, and a continual increase in the rotational speed of the disk stack to decrease the data transfer time. As storage densities and rotational speeds increase, the ability to position the read/write heads to the proper data tracks and maintain the heads on the data tracks becomes more difficult. As disk-stack rotational speed increases, air-flow turbulence near the perimeter of the disks increases, which causes vibration of the arms and suspensions and thus the read/write heads, and out-of-plane buffeting or vibration (often called “flutter”) of the disks. These vibrations can cause read/write head positioning errors and thus errors in reading data from and writing data to the data tracks.

Disk vibration damping plates have been proposed, as described in published U.S. patent application US 2003/0072103 A1, published Apr. 17, 2003. These damping plates have planar surfaces parallel to the planar surfaces of the disks and extend between the disks near their perimeter. These planar damping plates encourage laminar air flow and thus a reduction in turbulence. However, these damping plates also cause high viscous shear forces on the disks, which require a higher spindle-motor torque, and thus higher power consumption, to maintain the desired high rotational speed. Low power-consumption is a critical requirement in disk drives, particularly disk drives used in portable devices, such as laptop computers and handheld audio/video players.

What is needed is a disk drive that can achieve minimal air-flow turbulence without a significant increase in power consumption.

### SUMMARY OF THE INVENTION

The invention is a disk drive with nonplanar damping plates that reduce spindle motor torque, as compared with planar damping plates, while maintaining steady laminar air flow at the disk stack perimeter. Each damping plate has a nonplanar surface that results in spacing between the stationary plate surface and its associated rotating disk surface that varies in the radial direction. In one embodiment the damping plate has a pattern of surface irregularities or features. The surface features can be arranged in concentric patterns, such as a pattern of concentric grooves, depressions or protuberances. In another embodiment the nonplanar surface of the damping plate is shaped as a section of a conic surface so that the spacing between the damping plate and its associated disk surface varies linearly in the radial direction. The damping plates reduce the viscous shear forces on the disks while maintaining substantially steady laminar air flow between the disks.

For a fuller understanding of the nature and advantages of the present invention, reference should be made to the following detailed description taken together with the accompanying figures.

### BRIEF DESCRIPTION OF THE DRAWINGS

FIG. 1 is a top view of a prior art disk drive with the disk stack and spindle motor removed to show the damping plates.

FIG. 2 is a perspective view of a stack of prior art damping plates.

FIG. 3 is a sectional view of a portion of a prior art disk drive illustrating the disk stack and damping plates.

FIG. 4A and FIG. 4B are perspective and cross-sectional views, respectively, of a first embodiment of a damping plate according to the present invention.

FIG. 5 is a sectional view of the damping plate of FIGS. 4A-4B and a portion of its two associated axially-spaced disks.

FIG. 6A and FIG. 6B are perspective and cross-sectional views, respectively, of a second embodiment of the damping plate according to the present invention in which the nonplanar surfaces have surface features.

FIG. 7A and FIG. 7B are perspective and cross-sectional views, respectively, of a third embodiment of the damping plate according to the present invention.

### DETAILED DESCRIPTION OF THE INVENTION

Prior Art

The disk drive includes a housing 10 that is typically formed with a base 12 and a surrounding wall 14. An actuator, typically a voice coil motor (VCM) actuator, is supported on base 12. The VCM includes a rotary portion rotatable about axis 20 and comprising a stack of arms, such as top arm 22, and a coil assembly 24; and a fixed portion comprising a magnet assembly 26 mounted to base 12. Each actuator arm includes a suspension and a head assembly, such as suspension 28 and head assembly 30 attached to arm 22.

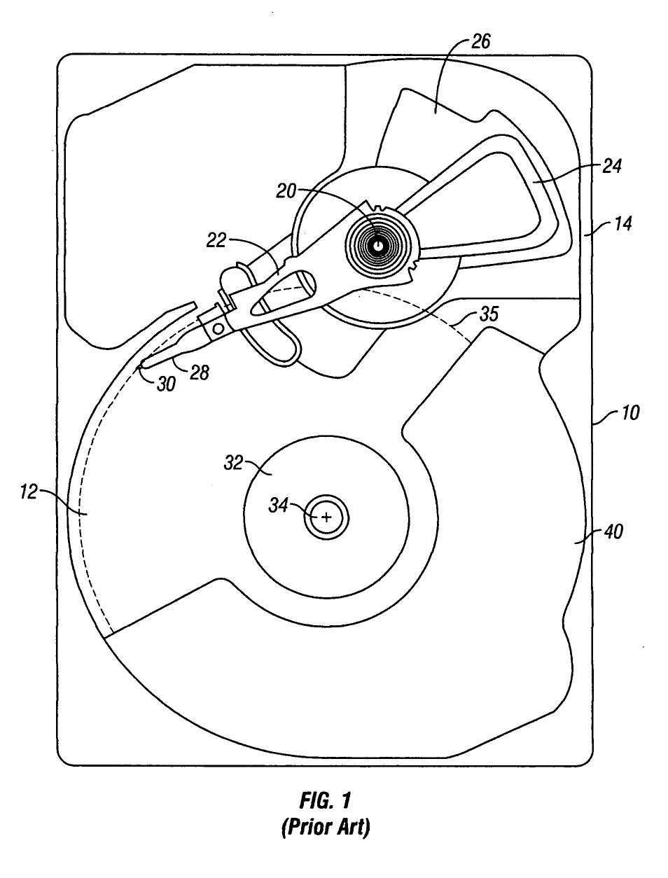

The disk drive includes a stack of hard magnetic recording disks mounted on a rotatable hub attached to a spindle motor. The assembly comprising the disk stack, hub, and spindle motor is mounted to the housing base 12 in the region 32 with the disk stack rotatable about a common axis 34, but this assembly is not depicted in FIG. 1 so that the location of the damping plates can be better illustrated. The outer perimeter of the disk stack is represented by dashed circle 35.

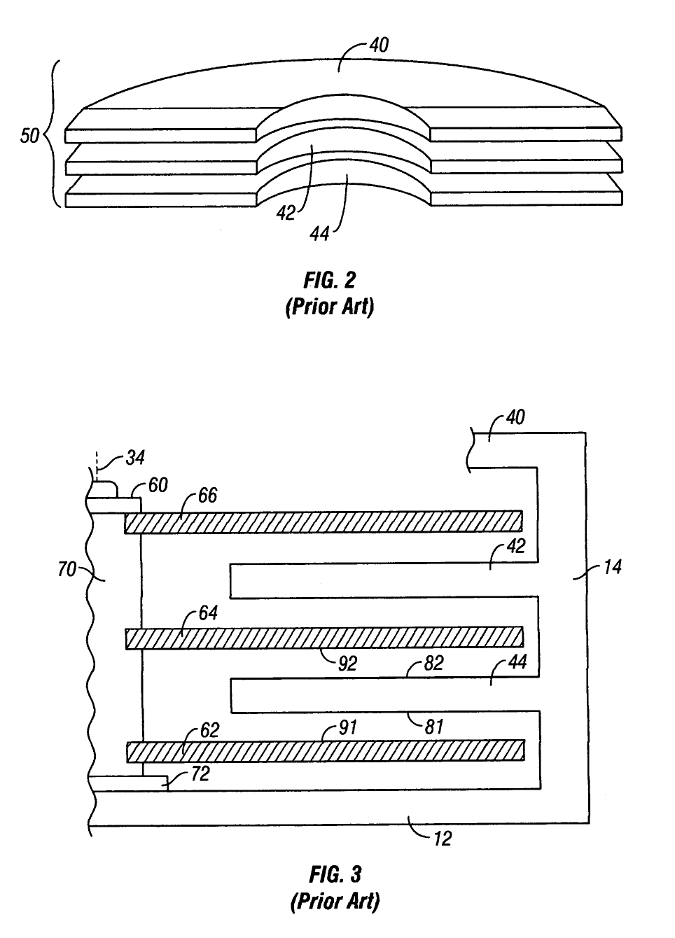

The damping plates, such as top plate 40 in FIG. 1, reduce out-of-plane vibration of the disks during rotation. FIG. 2 is a perspective view of a stack 50 of individual damping plates 40, 42, 44. As shown in the top view of FIG. 1, relative to the disk rotational axis 34, each damping plate, such as top plate 40, extends over a radially outer annular sector of the region swept by the rotating disks. The damping plate stack 50 is shown in FIG. 1 as being integrally formed with the housing wall 14 as part of the fabrication of housing 10. However, the stack 50 may also be formed as a separate assembly and mounted to base 12 or wall 14 after fabrication of housing 10.

FIG. 3 is a sectional view of a portion of the disk drive housing 10 illustrating the disk stack 60 mounted to base 10 and damping plates 40, 42, 44 extending from housing wall 14. The disk stack 60 includes three axially-spaced disks 62, 64, 66 mounted to a hub 70. The damping plate stack 50 has a top plate 40 with a bottom surface that faces top disk 66. Each of the other two damping plates in stack 50 is associated with a set of two axially-adjacent disks in the disk stack 60, such as plate 44 with disks 62, 64, and plate 42 with disks 64, 66. So in the example of FIG. 3, the disk stack has 3 disks, and there are 2 damping plates, each of the 2 damping plates being located between and axially-adjacent pair of disks and each of the 2 damping plates having two planar damping surfaces. The hub 70 rotates about axis 34 and is attached to a spindle motor (not shown) whose base 72 is mounted to housing base 10. In the prior art disk drive of FIG. 3, each damping plate has planar surfaces that are parallel with a corresponding planar disk surfaces. For example, plate 44 has a planar surface 81 parallel to corresponding planar surface 91 of disk 62, and a planar surface 82 parallel to corresponding planar surface 92 of disk 64.

The purely planar surfaces of the damping plates of the prior art reduce out-of-plane vibrations of the disks, but at the cost of significantly increased spindle motor torque required to rotate the disk stack.

### DESCRIPTION OF THE PREFERRED EMBODIMENT

In the present invention the damping plates have substantially nonplanar surfaces compared to the substantially planar surfaces of the disks.

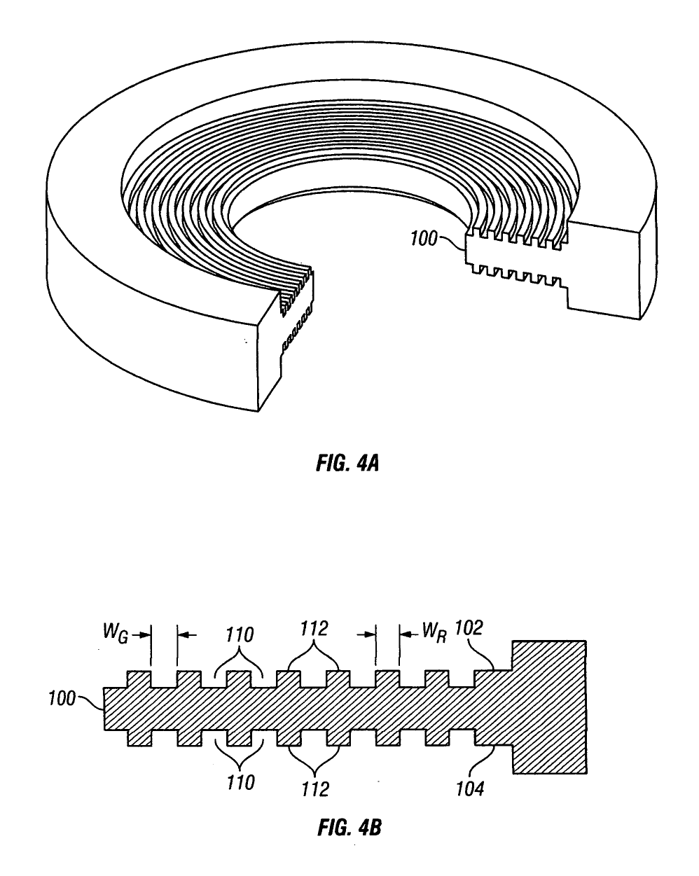

FIG. 4A is a perspective view and FIG. 4B a cross-sectional view of a first embodiment of a damping plate 100 according to the present invention. Each of the two surfaces 102, 104 is a plurality of radially-spaced concentric grooves 110 separated by radially-spaced ribs 112. The grooves are depicted as being equally radially spaced, with each groove having a radial width w_{G} and each rib a radial width w_{R}. This design simplifies simulation of the air flow dynamics by selecting the ratio w_{G}/w_{R} to be one of the design variables. However, the advantages of the present invention are also achievable if the grooves are not equally radially-spaced and if the grooves do not all have the same depth or radial width. While the grooves in FIGS. 4A-4B have generally rectangular cross-sectional shapes, they may have other shapes, such as triangular, semicircular, etc.

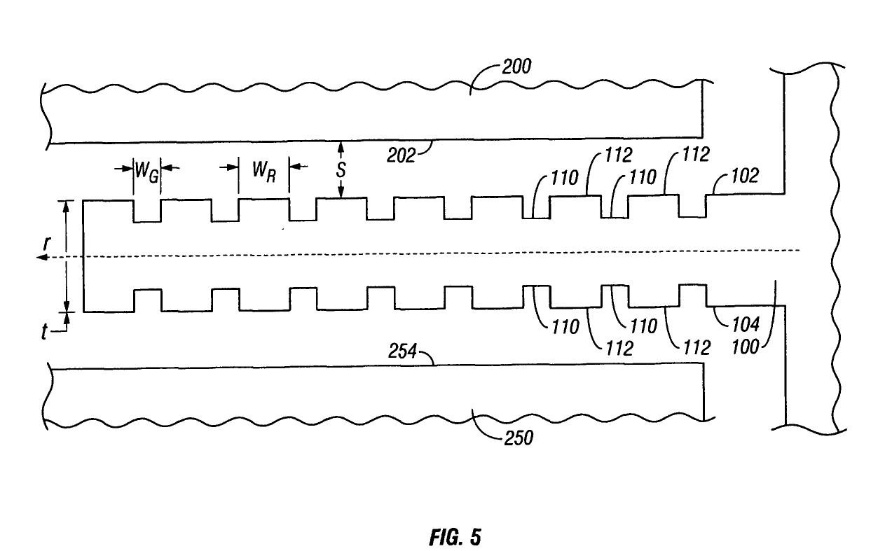

FIG. 5 is a sectional view of the damping plate of FIGS. 4A-4B and a portion of its two associated axially-spaced disks 200, 250. Disk 200 has a substantially planar surface 202 that faces surface 102 of plate 100 and disk 250 has a substantially planar surface 254 that faces surface 104 of plate 100. The axial spacing between the damping plate surface and its corresponding disk surface, such as spacing S between plate surface 102 and disk surface 202, varies along the radial extent r of the damping plate because of the grooves 110.

The damping plates have been described with respect to a disk drive having a stack of disks, with each damping plate located between two axially-spaced disks in the disk stack and having two nonplanar surfaces, each nonplanar surface facing a corresponding planar disk surface. For the disk surfaces facing the top and bottom of the disk housing, the nonplanar surfaces can be applied to the top and bottom of the disk housing. The invention is also applicable to a disk drive having a single disk. In such an embodiment a damping plate having a nonplanar surface according to the present invention may be incorporated as part of the disk drive base and/or on the bottom of the disk drive top cover. In this manner the disk drive base and/or disk drive cover includes a nonplanar surface facing the bottom surface and/or top surface, respectively, of the single disk. Thus, in the single disk case, no separate damping plate is needed.

A large-scale numerical simulation of disk drive internal aerodynamics was performed for various designs of the damping plate 100 using commercially available software, e.g., CFDRC-ACE (CFDRC Corp., Huntsville, Ala.). The simulation assumed a local velocity at the outer perimeter of the disks of 39.8 m/s, which corresponds approximately to a three-inch disk drive operating at 10,000 RPM. The spacing between the surfaces 102, 104 and their corresponding disk surfaces, 202, 254 measured at the top of the ribs was 2 mm, and the depth of the grooves was 0.2 mm. The simulation was run for different damping plate thicknesses t and different ratios of w_{G}:w_{R}. Flow-induced out-of-plane disk vibrations are not easily quantified. However, one measure of the risk of flow-induced vibration is the “Max Norm of the Eddy Viscosity” in the aerodynamic flow field. Eddy viscosity (sometimes referred to as turbulent viscosity) is larger than molecular viscosity in high Reynolds number flow. In the case of a 3-inch disk drive, the Reynolds number based on the disk radius can be in the neighborhood of 150,000, which would necessitate the use of a turbulent model in the flow calculation. Eddy viscosity can then be obtained from the flow model as an indication of how intensified the turbulence in the flow is. The main advantage of this measure is that it is a single number (scalar) that does not depend on the vibrating structures in the disk drive. Thus, the computed eddy viscosity from the flow field was used here as a figure of merit relating turbulence to disk vibrations. High values of turbulence near the perimeter of the disks 200, 250 indicate unsteady airflow leading to higher out-of-plane vibration of the disks. The viscous torque applied to the disks by the air flow was also determined from the simulation. High viscous torque represents high power consumption required to rotate the disk stack. Table 1 presents the results of the simulation.

TABLE 1

| | | | | viscous | |
|---|---|---|---|---|---|
| plate thickness | W_{G} | W_{R} | | torque | eddy viscosity |
| t (mm) | (mm) | (mm) | W_{G}:W_{R} | (N-m × 10⁻³) | (kg-s/m × 10⁻⁴) |
| 0.97 | 0 | 0 | NA | 1.44 | 1.602 |
| (planar-surface | | | | | |
| plate) | | | | | |
| 0.97 | 0.575 | 2.3 | 1:4 | 1.41 | 1.695 |
| 0.97 | 1.15 | 1.725 | 2:3 | 1.39 | 1.716 |
| 0.97 | 1.725 | 1.15 | 3:2 | 1.35 | 1.770 |
| 0.97 | 2.3 | 0.575 | 4:1 | 1.33 | 1.807 |
| 0.57 | 0 | 0 | NA | 1.30 | 2.012 |
| (planar-surface | | | | | |
| plate) | | | | | |
| 0.0 | — | — | — | 3.87 | 2.491 |
| (no plate) | | | | | |

As shown by the results of Table 1, the nonplanar damping plates provide the ability to reduce the viscous torque, and thus the power consumption of the disk drive, with relatively minor increases in turbulence (as represented by eddy viscosity). The nonplanar damping plates thus provide an important design option to optimize the trade-off between power consumption and out-of-plane disk buffeting, depending on the characteristics of the particular disk drive being developed, e.g., the size, rotational speed, and power-saving requirements.

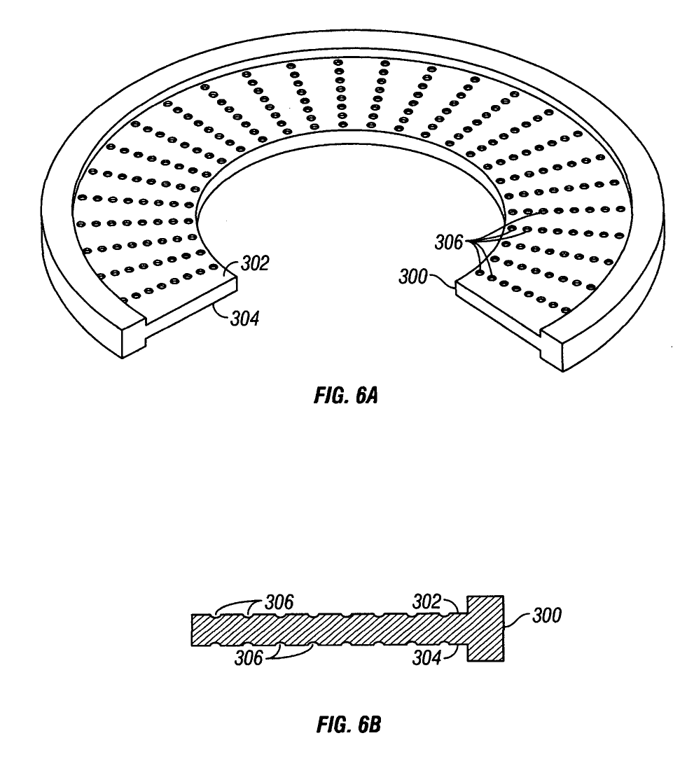

FIGS. 6A-6B illustrate a perspective view and cross-sectional view, respectively, of a second embodiment of the damping plate in which the nonplanar surfaces have discrete surface features. The damping plate 300 has nonplanar surfaces 302, 304, each of which is a pattern of radially-spaced depressions or dimples arranged in concentric rings around plate 300. Each dimple has a shape with a circular perimeter, but the shape can take other forms, such as elliptical, hexagonal, etc. The dimples can have a depth approximately that of the grooves in the embodiment of FIGS. 4A-4B, i.e. 0.2 mm. Also, the surface features can be protuberances or bumps, instead of dimples. The bumps can have a height approximately that of the grooves in the embodiment of FIGS. 4A-4B, i.e. 0.2 mm. While the surface features are shown in FIGS. 6A-6B as patterned in concentric rings around the plate, they need not be located in such a pattern. However, it is believed that this pattern provides concentric rings of substantially planar surfaces between the concentric rings of surface features, much like the rings of grooves and ribs in the embodiment shown in FIGS. 4A-4B and FIG. 5, which reduces the turbulent intensity along these rings.

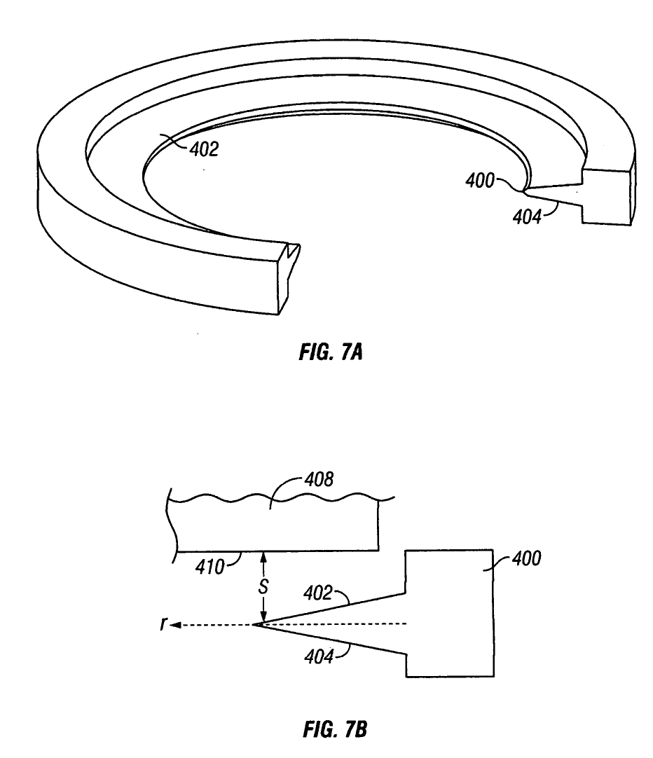

FIGS. 7A-7B illustrate a perspective view and cross-sectional view, respectively, of a third embodiment of the damping plate. The damping plate 400 has nonplanar surfaces 402, 404, each of which is section of a conical surface. As shown by FIG. 7B the axial spacing S between each damping plate surface and its corresponding planar disk surface, such as between nonplanar surface 402 and planar surface 410 of disk 408, varies linearly (increasing or decreasing) in the radial direction r of the plate.

The invention has been described with application to a magnetic recording hard disk drive, but the invention is fully applicable to any data recording disk drive with hard disks, such as disk drives that read and/or write by one or more of magnetic, optical, thermo-magnetic and magneto-optic techniques.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

1. A data recording disk drive comprising:
a housing;
at least one disk rotatable about an axis of rotation;
a motor attached to the housing for rotating the disk;
a plate fixed to the housing, the plate extending circumferentially around a sector of the disk and radially across a radially outer annular region of the disk, the plate having a surface facing a disk surface, the axial spacing between the plate's surface and the disk's surface varying along the radial extent of the plate.

2. The disk drive of claim 1 wherein there is only one disk, wherein the housing includes a base, the motor and disk being mounted on the base, and wherein the plate is part of the base, whereby the base has a surface facing the bottom surface of the disk.

3. The disk drive of claim 1 wherein there is only one disk, wherein the housing includes a base, the motor and disk being mounted on the base, and wherein the plate is part of the cover, whereby the cover has a surface facing the top surface of the disk

4. A data recording disk drive comprising:
a housing;
a rotatable stack of disks axially spaced along a common axis of rotation;
a motor attached to the housing for rotating the disk stack;
a plate fixed to the housing and located between two axially adjacent disks, the plate extending circumferentially around a sector of the two disks and radially across a radially outer annular region of the two disks, the plate having a first surface facing a surface of a first disk and a second surface facing a surface of the second disk, the axial spacing between the plate's first surface and the surface of the first disk varying along the radial extent of the plate.

5. The disk drive of claim 4 further comprising a plurality of plates, each plate being located between a different set of two axially adjacent disks.

6. The disk drive of claim 4 wherein at least one of the first and second surfaces of the plate comprises a plurality of radially-spaced concentric grooves, the grooves defining radially-spaced ribs.

7. The disk drive of claim 6 wherein the grooves are equally radially-spaced.

8. The disk drive of claim 7 wherein the ratio of the radial width of a groove to the radial width of a rib is between approximately 1:4 and 4:1.

9. The disk drive of claim 4 wherein at least one of the first and second surfaces of the plate comprises a plurality of discrete surface features.

10. The disk drive of claim 9 wherein the surface features are dimples.

11. The disk drive of claim 10 wherein the dimples are formed in a pattern of radially-spaced concentric dimples.

12. The disk drive of claim 9 wherein the surface features are bumps.

13. The disk drive of claim 12 wherein the bumps are formed in a pattern of radially-spaced concentric bumps.

14. The disk drive of claim 4 wherein at least one of the first and second surfaces of the plate is a section of a conical surface, whereby said axial spacing varies linearly along the radial extent of the plate.

15. A magnetic recording disk drive comprising:
a housing;
a rotatable stack of N hard disks axially spaced along a common axis of rotation, where N is greater than 1, each of the disks having a substantially planar surface;
a motor attached to the housing for rotating the disk stack;
N-1 plates fixed to the housing, each plate located between a unique set of two axially adjacent disks, each plate extending circumferentially around a sector of its two associated disks and radially across a radially outer annular region of its two associated disks, each plate having a first substantially nonplanar surface facing a substantially planar surface of a first disk in its set and a second nonplanar surface facing a substantially planar surface of the second disk in its set.

16. The disk drive of claim 15 wherein each of the first and second surfaces of each plate comprises a plurality of radially-spaced concentric grooves, the grooves defining radially-spaced ribs.

17. The disk drive of claim 16 wherein the grooves are equally radially-spaced.

18. The disk drive of claim 17 wherein the ratio of the radial width of a groove to the radial width of a rib is between approximately 1:4 and 4:1.

19. The disk drive of claim 15 wherein each of the first and second surfaces of each plate comprises a plurality of surface features.

20. The disk drive of claim 19 wherein the surface features are dimples.

21. The disk drive of claim 20 wherein the dimples are formed in a pattern of radially-spaced concentric dimples.

22. The disk drive of claim 19 wherein the surface features are bumps.

23. The disk drive of claim 22 wherein the bumps are formed in a pattern of radially-spaced concentric bumps.

24. The disk drive of claim 15 wherein each of the first and second surfaces of each plate is a section of a conical surface, whereby said axial spacing varies linearly along the radial extent of the plate.
